(19) United States
(12) Patent Application Publication
(10) Pub. No.: US 2025/0005048 A1
(43) Pub. Date: Jan. 2, 2025

(54) ONE-SHOT DOCUMENT SNIPPET SEARCH

(71) Applicant: Adobe Inc., San Jose, CA (US)

(72) Inventors: Abhinav JAVA, Noida (IN); Surgan JANDIAL, Jammu (IN); Shripad DESHMUKH, Solapur (IN); Milan AGGARWAL, Delhi (IN); Mausoom SARKAR, Noida (IN); Balaji KRISHNAMURTHY, Noida (IN); Arneh JAIN, Kozhikode (IN)

(73) Assignee: Adobe Inc., San Jose, CA (US)

(21) Appl. No.: 18/345,990

(22) Filed: Jun. 30, 2023

(51) Int. Cl. G06F 16/332

(52) U.S. Cl. CPC G06F 16/332

(57) ABSTRACT

Embodiments are disclosed for one-shot document snippet search. A method of one-shot document snippet search may include obtaining a query snippet and a target document. A multi-modal snippet detection model combines first multi-modal features from the query snippet and second multi-modal features from the target document to create a feature volume. The multi-modal snippet detection model identifies one or more matching snippets from the target document based on the feature volume.

### BACKGROUND

Documents are a popular way of storing information by businesses, governments, educational institutes etc. With the rise of personal computing, documents have transitioned from physical (e.g., paper), stored in the real world, to electronic, stored in the cloud. For example, physical copies of newly created documents are often no longer created, replaced by digital documents. Likewise, existing physical documents are increasingly converted to digital media formats like PDF. Modern document usage is no longer restricted only to reading or sharing, but is shifting to more active modes like authoring, editing styles, customizing figures and tables, among others. A key part of active usage is an advanced search mechanism. However, search functionality within documents is mostly limited to locating regions in a page containing text that matches a given textual query.

### SUMMARY

Introduced here are techniques/technologies that enable one-shot multi-modal document snippet search. A document snippet may include a portion of a document that may be characterized by text, image, spatial, and/or other features. Document snippet search allows for portions of a document with similar features (though not necessarily exactly the same content) to be identified. Embodiments perform one-shot document snippet search by extracting features corresponding to each modality from a query snippet and a target document to be searched. This may be performed using multiple encoders (e.g., a text encoder, an image encoder, a layout encoder, etc.).

Once the features have been extracted, they may be combined into co-attention and cross-attention feature sets. These may be formed by combining like features from the query snippet and the target document and combining unlike features from the query snippet and the target document. These feature sets can be used to create a feature volume from which regions of interest in the target document can be identified. These regions of interest correspond to predicted portions of the target document that match the query snippet.

Additional features and advantages of exemplary embodiments of the present disclosure will be set forth in the description which follows, and in part will be obvious from the description, or may be learned by the practice of such exemplary embodiments.

### BRIEF DESCRIPTION OF THE DRAWINGS

The detailed description is described with reference to the accompanying drawings in which:

FIG. 1 illustrates a diagram of a process of one-shot document snippet search in accordance with one or more embodiments;

FIG. 2 illustrates a diagram of a one-shot document snippet search user interface in accordance with one or more embodiments;

FIG. 3 illustrates an example of a one-shot document snippet search in accordance with one or more embodiments;

FIG. 4 illustrates an example of a model architecture for performing one-shot document snippet search in accordance with one or more embodiments;

FIG. 5 illustrates an example of an architecture of a symmetric attention module in accordance with one or more embodiments;

FIG. 6 illustrates an example of matching snippets in accordance with one or more embodiments;

FIG. 7 illustrates a schematic diagram of a document search system in accordance with one or more embodiments;

FIG. 8 illustrates a flowchart of a series of acts in a method of one-shot document snippet search in accordance with one or more embodiments; and

FIG. 9 illustrates a block diagram of an exemplary computing device in accordance with one or more embodiments.

### DETAILED DESCRIPTION

One or more embodiments of the present disclosure include a document search system which enables one-shot document snippet search of target documents. Document search in prior systems has been most often limited to identifying text that exactly matches a text query. While this kind of searching is effective for basic text editing, it cannot be used to search for any modalities other than text, such as layout, image content, etc. Other techniques, such as template matching, have attempted to provide a more intelligent search for similar content across documents. Template Matching refers to the task of detecting and localizing a given query image in a target (usually larger) image. Such techniques typically use traditional computer vision techniques like Normalized Cross Correlation (NCC) and Sum of Squares Differences (SSD) for searching.

Template matching techniques have clear limitations. For instance, they struggle when presented with a large variation in scale, occlusions, poor image quality, different lighting conditions, etc. Template matching also offers limited real-time use. The rise of deep learning has allowed researchers to develop more sophisticated searching techniques like QATM and DeepOneClass that perform matching between deep features of natural images for tasks like GPS localization. However, such techniques have not performed well when attempting to match templates within documents rather than from natural images. For example, documents may present diverse and complicated arrangement of layout, visual structures and textual content as compared to features across natural images.

Another prior technique is one shot object detection (OSOD). OSOD aims at detecting instances of novel classes (e.g., classes not seen during training) within a test image given a single example of the unseen/novel class. At a high level, most OSOD techniques perform alignment between deep features of a query (e.g., an example of a novel class) and a target image (e.g., a test image where the novel class instance is present). Such techniques have shown that the learned attention-based correlation can out-perform standard Siamese matching since they capture multi-scale context better through global and local attention. Popular OSOD techniques have been shown to perform well on natural images when class definitions are clearly specified. However, due to the complexity of document data and lack of a well-defined, yet exhaustive, set of layout patterns, it is not possible to enumerate a finite set of classes. More recently, attempts have been made to learn a hierarchical relationship (e.g., Balanced and Hierarchical Relation Learning or BHRL) between object proposals within a target and the query. While BHRL shows impressive performance on natural images, it does not leverage multi-modal information that is critical for document snippet detection.

As discussed, prior approaches to document search have been formulated in two distinct ways. First, as a retrieval task where a database of search items is matched against the user query. However, creating and storing large databases for complex modalities like document snippets is a non-trivial task. The number and types of snippets that may be queried is unbounded, meaning that even if such a database is created, the next snippet that is queried still may not be included in the database. As a result, such retrieval implementations can only be practically implemented for limited subsets of snippets, such as text and simple multi-modal structures like logos etc. The second formulation is as an object detection task where a fixed set of classes are detected by a function (e.g., a deep model or other machine learning technique). However, as in the retrieval case, document snippets can be arbitrarily complex making it likely impossible to fully train a model on all of the possible classes to which a snippet may belong. As such, these prior techniques have failed to provide effective results when applied to document snippet search.

As discussed, traditional text searching provides very limited functionality to the document author (e.g., find and replace and similar use cases related to exact text matching). However, there are a number of use cases where snippet searches would be much more useful. For example, a user may want to add a column to a particular kind of table to accommodate more statistics. In such an instance, the query snippet may include an example of the table to be edited. The target document would then be searched for similar tables (e.g., tables with the same number of columns, potentially with the same or different column labels). Similarly, a form author may want to add an extra field in an information collection question. In such an instance, the query snippet may include a question field that includes text (e.g., the question) and a document control (e.g., a menu of selectable answers to the question). Likewise, a schoolteacher may want to find a multiple-choice question with three options to edit it to four options. In such an instance, the query snippet may include an example multiple-choice question that includes three options.

In the above use cases, a traditional text search system would return, at best, search results that were under-inclusive. For example, the text search system would only return an exact match to the text of the query snippet, while missing any similar snippets with varying text content. Prior intelligent searching systems would require the model in use to be trained on the specific query classes to find potentially matching snippets, however even if such training had occurred the model would have only been trained on a single modality (e.g., image data of the class) making the search results less accurate.

Contrary to these existing approaches, embodiments use a one-shot multi-modal framework that fuses context from visual, textual, and spatial modalities across the query snippet and the target document. For example, when a user seeks to search a target document for a query snippet, multiple modalities of the query snippet and target document are encoded (e.g., a text encoder encodes the text content, an image encoder encodes the image content, etc.). These encoded representations (e.g., embeddings) of the query snippet and the target document are then combined using co-attention and cross-attention modules to create a combined feature representation. For example, in some embodiments, the output of the co-attention and cross-attention modules are 2D vector representations (e.g., encoded representations) which are then combined to form a 3D feature volume. The feature volume can then be used to identify candidate snippets of the target document that match the query snippet. As discussed further below, embodiments use a new model architecture that enables the fusion of multi-modal inputs, which results in more accurate snippet detection in documents.

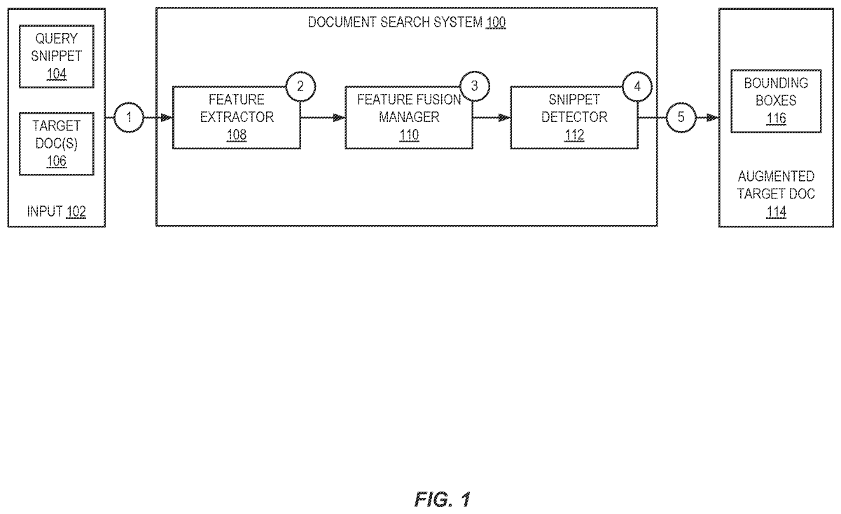

FIG. 1 illustrates a diagram of a process of one-shot document snippet search in accordance with one or more embodiments. As shown in FIG. 1, a document search system 100 can enable a user, service, or other entity to search for portions of one or more target documents that match a query snippet. In some embodiments, the document search system 100 may be implemented as part of an application or suite of applications. For example, in some embodiments, the document search system 100 is implemented as part of a document editing and creation system which enables the creation and/or editing of documents. In some embodiments, the document search system 100 may be implemented as a standalone application or service. In either instance, the document search system 100 may be implemented locally on a client computing device, remotely on a server computing device, or a combination thereof.

As shown in FIG. 1, to initiate a document snippet search, at numeral 1 the document search system 100 receives input 102 which includes a query snippet 104 and one or more target documents 106. Documents, as used herein, refers to multi-modal documents that includes a variety of visual content such as text data, image data, content controls, etc. Additionally, a snippet, as used herein, refers to a portion of a document which may include one or more of the modalities embodied by a given document.

In the example of FIG. 1, input 102 is received by feature extractor 108. Feature extractor 108 may include one or more encoders which encode information about the query snippet and the target document as features (e.g., embeddings). In some embodiments, feature extractor 108 may include an encoder for each modality of a snippet being analyzed. For example, an image encoder, text encoder, and layout (e.g., spatial) encoder may be used to generate embeddings that represent the image content, text content, and spatial content, of the query snippet 104 and the target document 106. The encoders may be implemented as one or more neural networks as are generally known in the art.

A neural network may include a machine-learning model that can be tuned (e.g., trained) based on training input to approximate unknown functions. In particular, a neural network can include a model of interconnected digital neurons that communicate and learn to approximate complex functions and generate outputs based on a plurality of inputs provided to the model. For instance, the neural network includes one or more machine learning algorithms. In other words, a neural network is an algorithm that implements deep learning techniques, i.e., machine learning that utilizes a set of algorithms to attempt to model high-level abstractions in data.

At numeral 2, the query snippet 104 and target document 106 are processed by the encoders of feature extractor 108 to generate a plurality of features. For example, each encoder outputs its own set of features for the query snippet and the target document. These features are then provided to feature fusion manager 110. As discussed further below, feature fusion manager 110 includes a co-attention module which combines like features from the query snippet and the target document, and a cross-attention module that combines unlike features from the query snippet and target document and outputs a fused combined feature representation. At numeral 3, feature fusion manager 110 combines the features extracted from the query snippet 104 and the target document 106 into a combined feature representation which is provided to snippet detector 112. For example, in some embodiments, the features extracted from the query snippet and the target document are each 2D feature vectors. When these 2D feature vectors are combined, they form a 3D feature volume.

The snippet detector 112 may include one or more detection heads which identify bounding boxes in the target document 106 associated with likely matches to the query snippet 104. At numeral 4, the feature volume is processed by the snippet detector 112 to identify matching snippets in the target document. At numeral 5, an augmented target document 114 is returned. In some embodiments, the augmented target document 114 has been augmented to include the bounding boxes identified by the snippet detector 112 which highlight matching snippets in the target document. In some embodiments, the augmented target document 114 is displayed to the user. Alternatively, the matching snippets may be displayed in isolation (e.g., removed from the target document). Additionally, or alternatively, the bounding box data (e.g., coordinates defining the bounding box) are returned to the requesting system to be used for further processing of the target document.

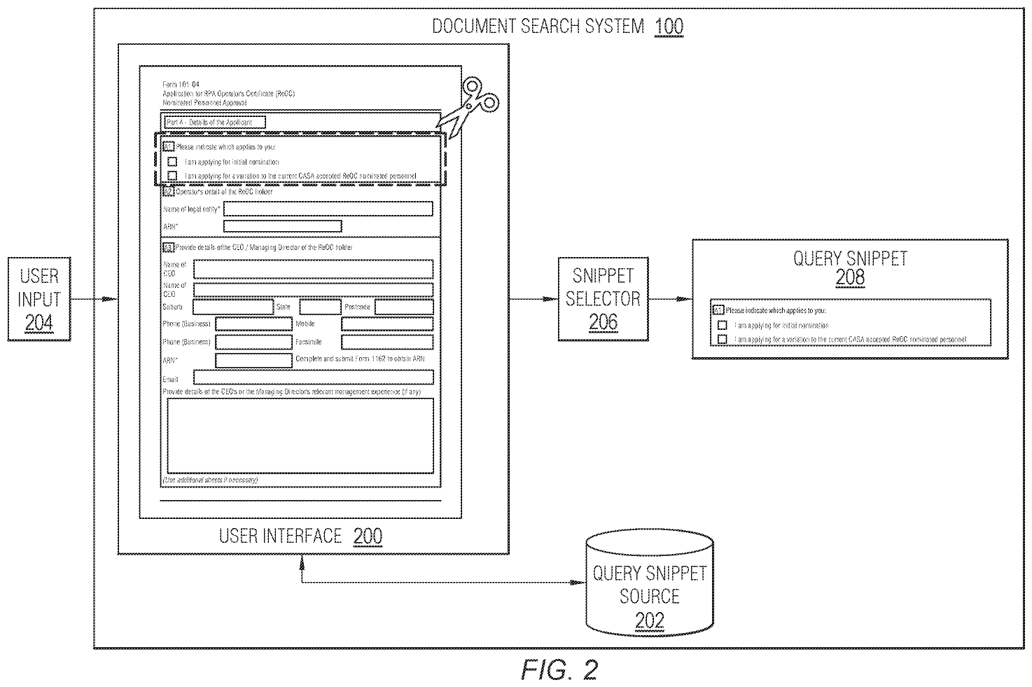

FIG. 2 illustrates a diagram of a one-shot document snippet search user interface in accordance with one or more embodiments. As shown in FIG. 2, the document search system 100 may include a user interface 200. The user interface may be a graphical user interface (GUI) through which one or more users interact with the document search system 100 to conduct a snippet search. As discussed, when a search of a target document is performed, the user may provide the target document to be searched and the query snippet. In some embodiments, the user may select the snippet from a document they possess, from the target document itself, or from another source.

For example, in some embodiments, the document search system 100 may include a query snippet source 202. The query snippet source may be a document store which includes a variety of potential snippets which the user may select from to use for searching a target document. This may be used, for example, to aid the user in document authoring or editing.

In some embodiments, the document from which the query snippet is to be taken from can be displayed in user interface 200. The user can then select the snippet from the document using the user interface. For example, the user may draw a rectangle, or other shape, around the snippet in the document. Information defining the selected region (e.g., coordinates, path objects, etc.) may be provided to snippet selector 206 which extracts the query snippet 208 from the document. In some embodiments, the snippet selector 206 may crop the query snippet from the document based on the user input (e.g., based on the bounding information provided by the user). In some embodiments, the snippet selector 206 may use a machine learning model to extract a portion of the document corresponding to the query snippet. The machine learning model may receive the document and the user input identifying the snippet and output a predicted portion of the document corresponding to the query snippet. This query snippet 208 is now available to search a target document for similar snippets.

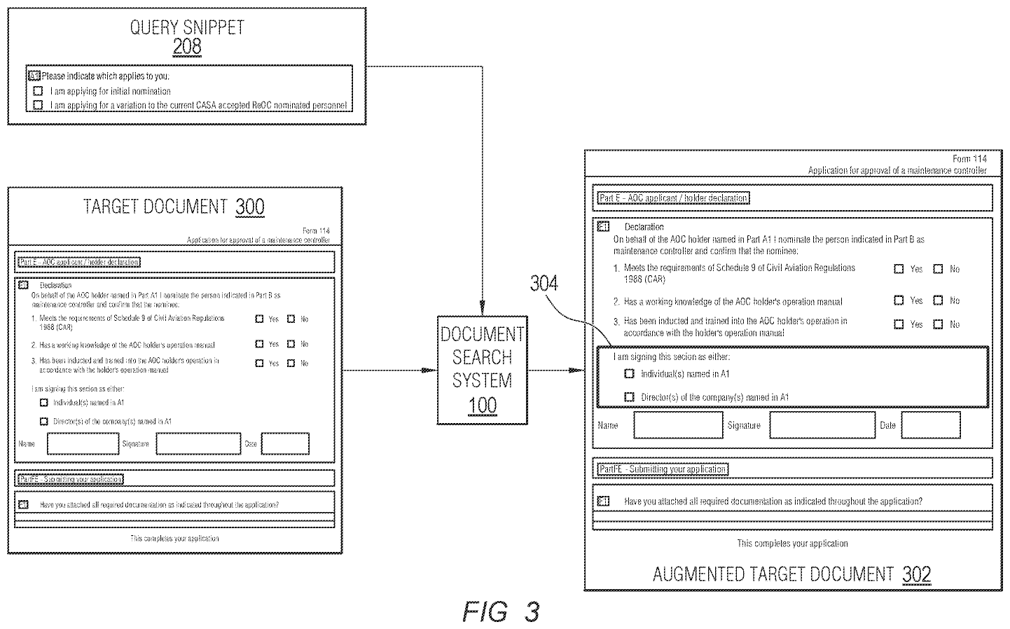

FIG. 3 illustrates an example of a one-shot document snippet search in accordance with one or more embodiments. As discussed, to perform a snippet search, the document search system 100 receives both the query snippet 208 and the target document 300 to be searched. As shown in FIG. 3, query snippet 208 is the query snippet selected by the user, as discussed above with respect to FIG. 2. In this example, the query snippet includes a line of text followed by two check boxes each associated with their own lines of text. Specifically, the query snippet reads:
A1 Please indicate which applies to you:
   [symbol] I am applying for initial nomination
   [symbol] I am applying for a variation to the current CASA accepted ReOC nominated personnel

The target document to be searched for similar snippets is a form titled Application for approval of a maintenance controller. Upon being searched by the document search system 100 for matching snippets to the query, the document search system identifies one target snippet. This is shown in augmented target document 302 and highlighted by bounding box 304. The matching snippet also includes a line of text followed by two check boxes each associated with their own lines of text. Specifically, the matching snippet reads:
I am signing this section as either:
   [symbol] Individual(s) named in A1
   [symbol] Director(s) of the company(s) named in A1

As can be seen, the text of the snippets is completely different, but the structure of the snippets is very similar. As a result, the document search system 100 allows users to find other versions of a query snippet, where its structure would be similar but the content, styles, fonts etc. might vary.

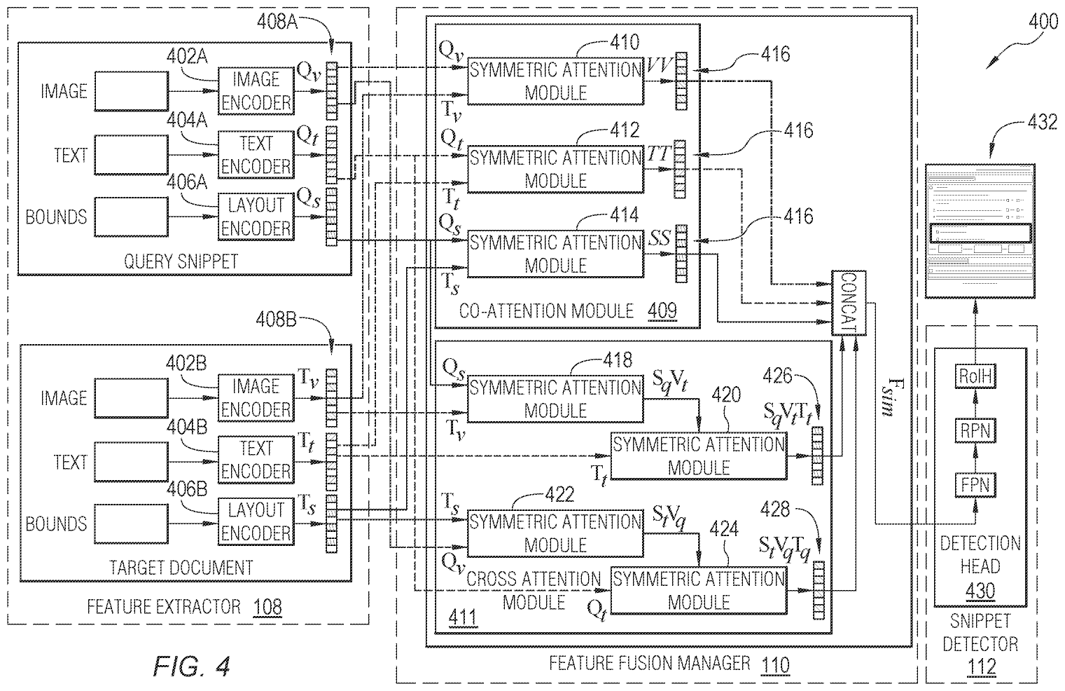

FIG. 4 illustrates an example of a model architecture for a multi-modal snippet detection model which performs one-shot document snippet detection in accordance with one or more embodiments. As discussed, prior document searching techniques have been framed as retrieval or object detection tasks. Embodiments instead define task of identifying a set of snippets matching a query-target pair within a dataset. For example, given a dataset [symbol] of query-target pairs (Q, T) which are generated using an oracle (not accessible afterwards), embodiments find snippets S_{qt} for each pair (Q, T) ∈ [symbol] . Let f_{θ} be a model with parameters θ which predicts similar snippets S_{qt} for a given (Q, T) pair. Let loss [symbol] be the measure of error between S_{qt} and Ŝ_{qt}, then the optimization problem is that of minimizing [symbol] as follows:

$${min}_{θ} {\sum }_{∀ ( Q , T ) ∈ 𝒟} ℒ ( {S}_{q t} , {\hat{S}}_{q t} )$$

Let [symbol] be the set of all document snippets. Similar snippets can be identified using a similarity criterion edit_{qt} based on the edit distance (e.g., Levenshtein distance), such that edit_{qt}: [symbol] ²→ [symbol] which takes two document snippets A, B ∈ [symbol] , and outputs a similarity score s=edit_{qt}(A, B). Essentially, the similarity score compares a distance between the layout of the query and a potential region in the target, this allows structurally similar query-target pairs to be formed for training. In some embodiments, this enables similarity search datasets to be created from various document datasets, such as the Flamingo forms dataset and PubLayNet document dataset2.

As shown in FIG. 4, the document search system includes a model architecture 400 that enables the multi-modal snippet detection model to perform one-shot snippet detection using image, text, and spatial context from the query and the target document. A possible way to leverage multi-modal context is to directly use a pre-trained model to obtain multi-modal embeddings for both query snippet and target document separately. However, doing so restricts interconnecting individual modalities between the query snippet and the target document. Instead, each modality for both the query snippet and the target document are encoded separately using image, text, and layout encoders which allows for the features to be processed together, as discussed further below.

As discussed, when a query is received, the query snippet and the target document are first processed by feature extractor 108. Feature extractor 108 may include an image encoder, a text encoder, and a layout encoder, each configured to generate a representation of the query snippet or target document. In some embodiments, the query snippet and target document may be processed by separate encoders (e.g., as shown in FIG. 4 as encoders 402A-406A and 402B-406B). Alternatively, these may be copies of the same encoders. In some embodiments, the same encoders are used to process the query snippet and the target document, with each being processed one after the other. As shown in FIG. 4, each encoder outputs a different type of feature vector (e.g., “feature type”) representing a single modality, depending on the encoder. For example, the feature type may include image, text, or spatial information for the query or target document, when generated by an image encoder, text encoder, or layout encoder, respectively. These representations are shown at 408A and 408B. These representations, each representing a different modality (e.g., referred to as multi-modal representations or multi-modal features) can then be combined by the feature fusion manager, as discussed further below.

In some embodiments, the image encoder 402A, 402B can be implemented as a Document Image Transformer (DiT)-backbone with encoder-only architecture having four layers, each including four attention heads with model dimension of 512. The image encoder receives a three-channel document image (e.g., RGB) resized (e.g., using bi-cubic interpolation) to 224×224 resolution which is further cut into 16×16 sized patches and outputs a token sequence of length 197. The 197 tokens are formed as follows

$$- \frac{224 \times 224}{16 \times 16} + 1 ,$$

where the additional token corresponds to the CLS token as in the original Bidirectional Encoder representation from Image Transformers (BEiT). In some embodiments, a pretrained DiT base model is used that has a hidden dimension of 768. Since both query image Qᵢ^{inp} and target image Tᵢ^{inp} are preprocessed to the same dimension, two feature vectors Qᵥ, Tᵥ are created, each of size BS×197×1024, where 1024 is the maximum sequence length and BS denotes the batch size. Note that the maximum sequence length is a hyperparameter choice that is chosen based on the maximum number of text-blocks in the target document. The encodings are then padded to final vectors Qᵥ, Tᵥ of size BS×1024×1024 each. The rationale behind doing so is to conveniently be able to perform the subsequent cross-attention with different modalities. The sequence of operations is as follows:

$${Q}_{v} = pad ( D ( {Q}_{i}^{inp} ) ) ∈ {ℛ}^{1024 \times 1024}$$

$${T}_{v} = pad ( D ( {T}_{i}^{inp} ) ) ∈ {ℛ}^{1024 \times 1024}$$

where D is the DiT image encoder, pad is the padding operation, and Qᵥ, Tᵥ are the final query and target image feature sets.

In some embodiments, the text encoder 404A, 404B is implemented as a pretrained BeRT-based sentence transformer. The text encoder generates a 768 dimensional embedding for a given block of text. In some embodiments, the continuous blocks of text in the query and in the target document are fed into this encoder to generate token sequence Tₜ^{inp}, Qₜ^{inp} of dimension BS×textₜ×768 and BS×text_{q}×768 respectively, where textₜ is the number of text-blocks in the target document and text_{q} is the number of text-blocks in the query snippet. Additionally, both Tₜ^{inp}, Qₜ^{inp} can be padded to a constant size of BS×1024×768. Unlike other MONOMER parameters, in some embodiments, the text encoder weights are kept frozen. Mathematically, text encoding is represented as follows:

$${Q}_{t} = B ( p a d ( {Q}_{i}^{i n p} ) ) ∈ {ℛ}^{1024 \times 768}$$

$${T}_{t} = B ( p a d ( {T}_{i}^{i n p} ) ) ∈ {ℛ}^{1024 \times 768}$$

where Qₜ, Tₜ are the final query and target text feature sets and B is the BeRT text encoder.

In some embodiments, the layout encoder 406A, 406B is implemented as a vision transformer (ViT). The layout encoder encodes bounding box (e.g., spatial) information in the target document and query snippet. In some embodiments, the layout encoder is implemented using an encoder-only transformer architecture with four layers, four heads, and hidden dimension of 1024. The layout encoder receives bounds of the target Tₛ^{inp} and query snippet Qₛ^{inp} of size BS×boxₜ×4, and BS×box_{q}×4, where boxₜ and box_{q} are the number of bounding boxes in the target and query, respectively. Similar to the text-encoder, boxₜ and box_{q} are padded to the maximum sequence length of 1024. In some embodiments, weights of this encoder are initialized randomly. The bounding box encoding can be denoted as follows:

$${Q}_{s} = V ( p a d ( {Q}_{s}^{i n p} ) ) ∈ {ℛ}^{1024 \times 1024}$$

$${T}_{s} = V ( p a d ( {T}_{s}^{i n p} ) ) ∈ {ℛ}^{1024 \times 1024}$$

where V is the layout encoder and Qₛ and Tₛ are the final feature sets corresponding to the query snippet and target document, respectively.

Once the feature sets (e.g., embeddings) are generated for the query snippet and the target document, as discussed above, the feature sets are provided to the feature fusion manager 110 for further processing. As shown in FIG. 4, feature fusion manager 110 includes co-attention module 409 and cross-attention module 411. Co-attention module 409 and cross-attention module 411 may be implemented as transformer networks which combine like features (e.g., in the co-attention module) and unlike features (e.g., in the cross-attention module). The resulting combined features are then fused to create a feature volume which can be used to predict matching snippets in the target document.

As shown in FIG. 4, the co-attention module 409 and cross-attention module 411 each include symmetric attention modules 410-414 and 418-424. Each symmetric attention module includes two multi-head attention (MHA) modules which each include four heads and have an embedding dimension of 512. To ensure that the input token feature dimension matches with the MHA's specifications, the input sequences are passed through fully-connected layers to project feature dimensions onto a dimension of 512. The outputs of the MHA blocks are concatenated (e.g., along the last dimension) to obtain a final token sequence with feature dimension of BS×1024×1024. In particular, co-attention module 409 includes three symmetric attention modules, one for each modality, outputting co-attention feature sets 416 VV, TT, and SS, each of length 1024 and token size 1024.

$$V V = S A ( {Q}_{v} , {T}_{v} ) ∈ {ℛ}^{1024 \times 1024}$$

$$TT = S A ( {Q}_{t} , {T}_{t} ) ∈ {ℛ}^{1024 \times 1024}$$

$$SS = S A ( {Q}_{s} , {T}_{s} ) ∈ {ℛ}^{1024 \times 1024}$$

where SA is the Symmetric Attention operation.

Similarly, the cross-attention module 411 includes two symmetric attention modules (e.g., 418 and 422) for generating spatio-visual features and two for attending text over those generated features (e.g., 420 and 424). The cross-attention module 411 generates cross-attention feature sets S_{q}VₜTₜ 426 and SₜV_{q}T_{q} 428, the dimensions of which are length of 1024 and token size of 1024. The co-attention feature sets 416 are then combined with the cross-attention feature sets 426, 428 to create feature volume Fₛᵢₘ, which is provided to snippet detector 112. In some embodiments, the feature volume is formed by concatenating the co-attention feature sets 416 and cross-attention feature sets 426, 428. Fₛᵢₘ can be represented as:

$${S}_{q} {V}_{t} = S A ( {Q}_{s} , {T}_{v} ) ∈ {ℛ}^{1024 \times 1024}$$

$${S}_{q} {V}_{t} {T}_{t} = S A ( {S}_{q} {V}_{t} , {T}_{t} ) ∈ {ℛ}^{1024 \times 1024}$$

$${S}_{t} {V}_{q} = S A ( {T}_{s} , {Q}_{v} ) ∈ {ℛ}^{1024 \times 1024}$$

$${S}_{t} {V}_{q} {T}_{q} = S A ( {S}_{t} {V}_{q} , {Q}_{t} ) ∈ {ℛ}^{1024 \times 1024}$$

$${F}_{s i m} = concat ( VV , TT , SS , {S}_{q} {V}_{t} {T}_{t} , {S}_{t} {V}_{q} {T}_{q} )$$

where Fₛᵢₘ ∈ [symbol] ^{1024×1024} is the feature volume. This feature volume includes the information to find the relevant snippets within the target.

As shown in FIG. 4, snippet detector 112 includes a detection head 430 that receives the feature volume Fₛᵢₘ from feature fusion manager 110. Fₛᵢₘ represents the combined features of the query snippet and the target document as discussed above. In some embodiments, the detection head applies a linear projection on Fₛᵢₘ and converts it to a vector of shape BS×1024×4096. This vector is then reshaped into a feature volume F^{feat} ∈ [symbol] ^{BS×1024×64×64}. F_{feat} is then processed by a sequence of convolutional layers, each with a kernel size of 1, followed by LeakyReLU activation (slope=0.1) to output features at 4 different levels, with shape BS×256×64×64, BS×512×64×64, BS×1024×64×64, and BS×2048×64×64. The hierarchical features are subsequently processed through a feature pyramid network (FPN) architecture, followed by a region proposal network (RPN), such as FasterRCNN, and region of interest (RoI) heads to obtain the final bounding boxes. The FPN returns features at a common representation size of 1024. The RPN outputs proposed regions of the target document that are predicted to be most similar to the query snippet. The RoI head then outputs bounding boxes corresponding to the predicted regions, as shown at 432.

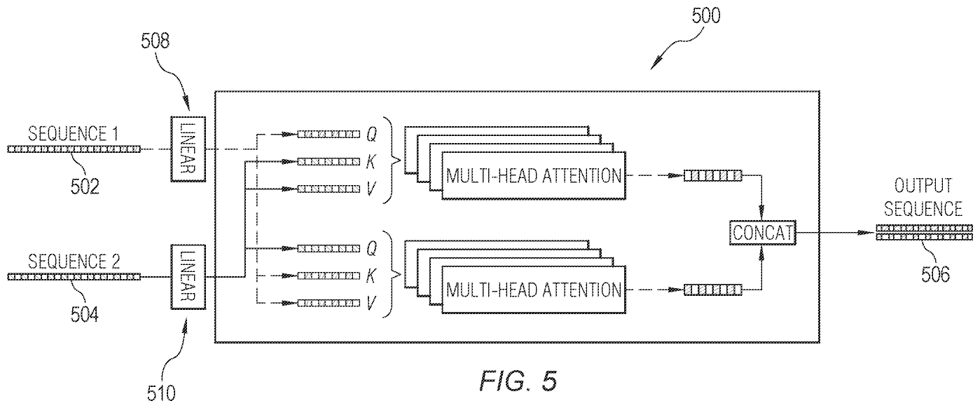

FIG. 5 illustrates an example of an architecture of a symmetric attention module in accordance with one or more embodiments. The architecture shown in FIG. 5 is one example of a symmetric attention module that may be used in accordance with various embodiments. Although this particular architecture is described herein, alternative architectures that combine two input sequences to generate an output sequence may be used. As shown in FIG. 5, a symmetric attention module 500 receives two input sequences 502, 504 and produces an output sequence 506. In some embodiments, each sequence 502, 504 are first processed using multilayer perceptrons (MLPs) 508, 510 to make the feature dimensions same. Then, two symmetric variations of multi-head attention operations are performed. In particular, where sequence 1 is treated as the query, and sequence 2 is treated as key and value; and where sequence 2 is treated as the query, and sequence 1 is treated as key and value. The outputs of these are concatenated along the feature dimension to generate final output sequence 506.

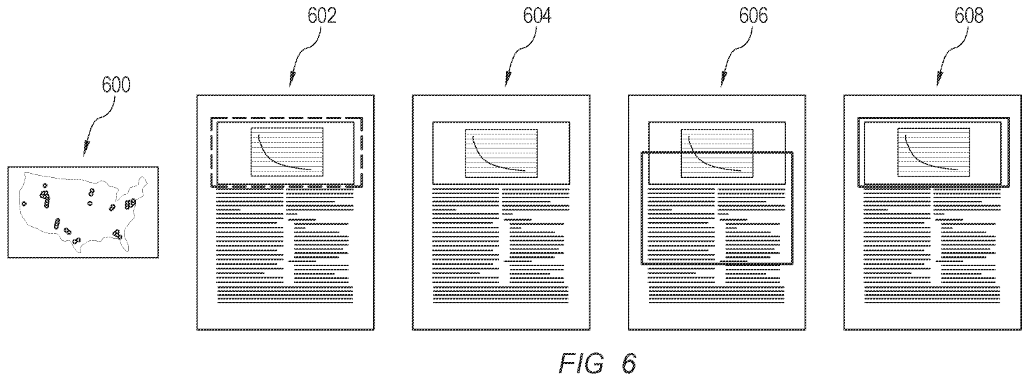

FIG. 6 illustrates an example of matching snippets in accordance with one or more embodiments. The example of FIG. 6 shows a comparison of different techniques for matching a query snippet 600 to a target document. In this example, the query snippet 600 is a chart showing data overlaid on a map of the United States with text describing the chart. The ground truth 602 is a bounding box around a chart in the target document. Although the charts are not visually similar, they are structurally similar to one another which makes them a match.

The first technique used is Balanced and Hierarchical Relation Learning (BHRL). As shown at 604, BHRL did not identify any matching snippets in the target document. The second technique is LayoutLMv3 which uses a pretrained model to perform various document AI tasks. As shown at 606, LayoutLMv3 results in a bounding box covering part of the chart in the target document along with a significant portion of the target document's text. While LayoutLMv3 identified a match, it was very imprecise. However, as shown at 608, the embodiments described herein were able to correctly identify the chart of the target document as matching the query snippet 600. In general, embodiments were found to predict correct bounds of matching snippets while making fewer extraneous predictions than prior techniques.

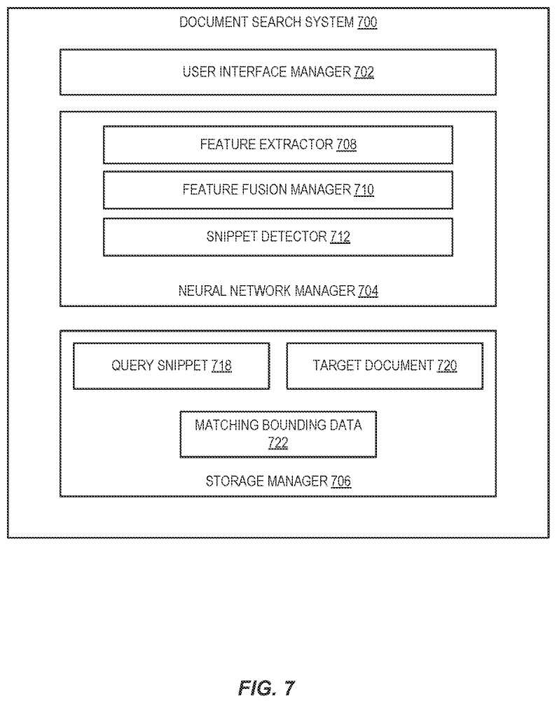

FIG. 7 illustrates a schematic diagram of document search system (e.g., “document search system” described above) in accordance with one or more embodiments. As shown, the document search system 700 may include, but is not limited to, user interface manager 702, neural network manager 704, and storage manager 706. The neural network manager 704 includes a feature extractor 708, a feature fusion manager 710, and a snippet detector 712. The storage manager 706 includes query snippet 718, target document 720, and matching bounding data 722.

As illustrated in FIG. 7, the document search system 700 includes a user interface manager 702. For example, the user interface manager 702 allows users to provide a query snippet and target document to the document search system 700. In some embodiments, the user interface manager 702 provides a user interface through which the user can upload the query snippet and target document, as discussed above. Alternatively, or additionally, the user interface may enable the user to select the query snippet and target document from a local or remote storage location (e.g., by providing an address (e.g., a URL or other endpoint)).

Additionally, the user interface manager 702 allows users to request the document search system 700 to search the target document for snippets matching the query snippet. For example, the user can select a query snippet using the user interface. In some embodiments, this selection may be made by selecting a region of a document that includes the query snippet. Selection may be performed by drawing the region (e.g., using a box tool, a free hand tool, etc.). The user may then request that the document search system search the target document for similar snippets to the query snippet. The document search system may then perform the techniques described herein to identify matching snippets.

As illustrated in FIG. 7, the document search system 700 also includes a neural network manager 704. Neural network manager 704 may host a plurality of neural networks or other machine learning models, such as encoders, transformers, etc. The neural network manager 704 may include an execution environment, libraries, and/or any other data needed to execute the machine learning models. In some embodiments, the neural network manager 704 may be associated with dedicated software and/or hardware resources to execute the machine learning models.

As discussed, feature extractor 708 may include a plurality of encoders (e.g., text encoders, image encoders, spatial encoders, etc.) which receive the query snippet and the target document and generate, e.g., text features, image features, and spatial features that represent the query snippet and target document. The encoders may be implemented as neural networks, such as transformers or networks of transformers, as discussed above. Once the features have been generated for the query snippet and the target document, the features are provided to feature fusion manager 710.

As discussed, the feature fusion manager 710 may include a plurality of transformer networks, including a co-attention module and a cross-attention module. The co-attention module combines like features from the query snippet and the target document, and the cross-attention module combines unlike features from the query snippet and the target document. The resulting feature sets are then combined to form a feature volume that is provided to snippet detector 112.

As discussed, snippet detector 712 may include a detection head which generates hierarchical features from the feature volume received from the feature fusion manager 110. In some embodiments, hierarchical features are subsequently processed through a feature pyramid network (FPN) architecture, followed by a region proposal network (RPN), such as FasterRCNN, and region of interest (RoI) heads to obtain the final bounding boxes. The FPN returns features at a common representation size of 1024. The RPN outputs proposed regions of the target document that are predicted to be most similar to the query snippet. The RoI head then outputs bounding boxes corresponding to the predicted regions. In some embodiments, the bounding boxes are used to create an augmented target document by overlaying the bounding boxes on the target document.

Although depicted in FIG. 7 as being hosted by a single neural network manager 704, in various embodiments the neural networks may be hosted in multiple neural network managers and/or as part of different components. For example, the feature extractor, feature fusion manager, and snippet detector can be hosted by their own neural network manager, or other host environment, in which the respective neural networks execute, or the networks may be spread across multiple neural network managers depending on, e.g., the resource requirements of each network, etc.

As illustrated in FIG. 7, the document search system 700 also includes the storage manager 706. The storage manager 706 maintains data for the document search system 700. The storage manager 706 can maintain data of any type, size, or kind as necessary to perform the functions of the document search system 700. The storage manager 706, as shown in FIG. 7, includes the query snippet 718. The query snippet 718 can include a portion of a document, as discussed in additional detail above. In particular, in one or more embodiments, the query snippet 718 includes text, image, and layout content which the user, or other entity, wishes to search for in the target document. As discussed, the query snippet may be uploaded to the document search system by the user or be otherwise accessible to the document search system.

As further illustrated in FIG. 7, the storage manager 706 also includes target document 720. Target document 720 can include any multi-modal document that may be searched by the document search system 700. The storage manager 706 may also include layout matching bounding data 722. The matching bounding data 722 may include coordinates that define at least one bounding box in the target document. As discussed above, the matching bounding data may be output by the snippet detector 712 and may identify portions of the target document that are predicted to match the query snippet.

Each of the components 702-706 of the document search system 700 and their corresponding elements (as shown in FIG. 7) may be in communication with one another using any suitable communication technologies. It will be recognized that although components 702-706 and their corresponding elements are shown to be separate in FIG. 7, any of components 702-706 and their corresponding elements may be combined into fewer components, such as into a single facility or module, divided into more components, or configured into different components as may serve a particular embodiment.

The components 702-706 and their corresponding elements can comprise software, hardware, or both. For example, the components 702-706 and their corresponding elements can comprise one or more instructions stored on a computer-readable storage medium and executable by processors of one or more computing devices. When executed by the one or more processors, the computer-executable instructions of the document search system 700 can cause a client device and/or a server device to perform the methods described herein. Alternatively, the components 702-706 and their corresponding elements can comprise hardware, such as a special purpose processing device to perform a certain function or group of functions. Additionally, the components 702-706 and their corresponding elements can comprise a combination of computer-executable instructions and hardware.

Furthermore, the components 702-706 of the document search system 700 may, for example, be implemented as one or more stand-alone applications, as one or more modules of an application, as one or more plug-ins, as one or more library functions or functions that may be called by other applications, and/or as a cloud-computing model. Thus, the components 702-706 of the document search system 700 may be implemented as a stand-alone application, such as a desktop or mobile application. Furthermore, the components 702-706 of the document search system 700 may be implemented as one or more web-based applications hosted on a remote server. Alternatively, or additionally, the components of the document search system 700 may be implemented in a suite of mobile device applications or “apps.”

As shown, the document search system 700 can be implemented as a single system. In other embodiments, the document search system 700 can be implemented in whole, or in part, across multiple systems. For example, one or more functions of the document search system 700 can be performed by one or more servers, and one or more functions of the document search system 700 can be performed by one or more client devices. The one or more servers and/or one or more client devices may generate, store, receive, and transmit any type of data used by the document search system 700, as described herein.

In one implementation, the one or more client devices can include or implement at least a portion of the document search system 700. In other implementations, the one or more servers can include or implement at least a portion of the document search system 700. For instance, the document search system 700 can include an application running on the one or more servers or a portion of the document search system 700 can be downloaded from the one or more servers. Additionally or alternatively, the document search system 700 can include a web hosting application that allows the client device(s) to interact with content hosted at the one or more server(s).

For example, upon a client device accessing a webpage or other web application hosted at the one or more servers, in one or more embodiments, the one or more servers can provide access to the document search system. The client device can receive a request (i.e., via user input) to search for content in one or more target documents that match a query snippet, and provide the request to the one or more servers. As discussed, the query snippet and target documents may be provided to the document search system to conduct a search. Upon receiving the request, the one or more servers can automatically perform the methods and processes described above to identify matching content in the target document(s). The one or more servers can provide all or portions of the matching content to the client device for display to the user.

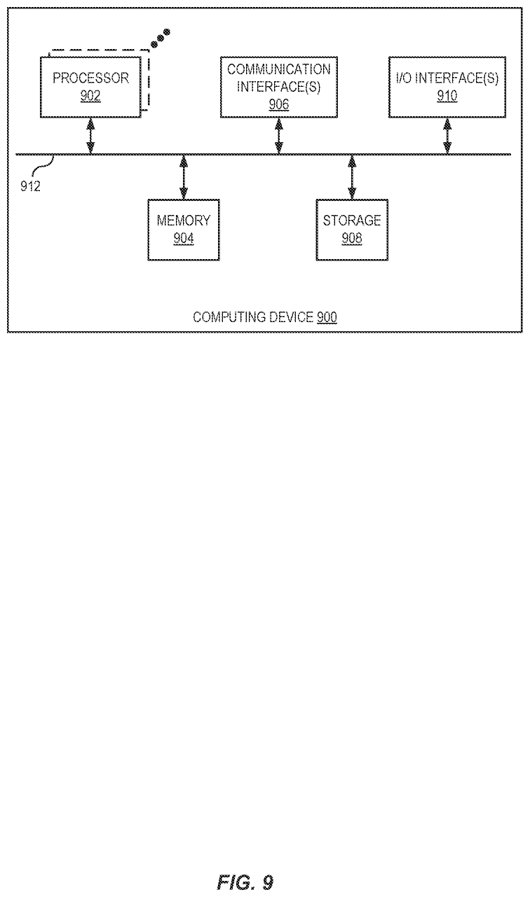

The server(s) and/or client device(s) may communicate using any communication platforms and technologies suitable for transporting data and/or communication signals, including any known communication technologies, devices, media, and protocols supportive of remote data communications, examples of which will be described in more detail below with respect to FIG. 9. In some embodiments, the server(s) and/or client device(s) communicate via one or more networks. A network may include a single network or a collection of networks (such as the Internet, a corporate intranet, a virtual private network (VPN), a local area network (LAN), a wireless local network (WLAN), a cellular network, a wide area network (WAN), a metropolitan area network (MAN), or a combination of two or more such networks. The one or more networks will be discussed in more detail below with regard to FIG. 9.

The server(s) may include one or more hardware servers (e.g., hosts), each with its own computing resources (e.g., processors, memory, disk space, networking bandwidth, etc.) which may be securely divided between multiple customers (e.g. client devices), each of which may host their own applications on the server(s). The client device(s) may include one or more personal computers, laptop computers, mobile devices, mobile phones, tablets, special purpose computers, TVs, or other computing devices, including computing devices described below with regard to FIG. 9.

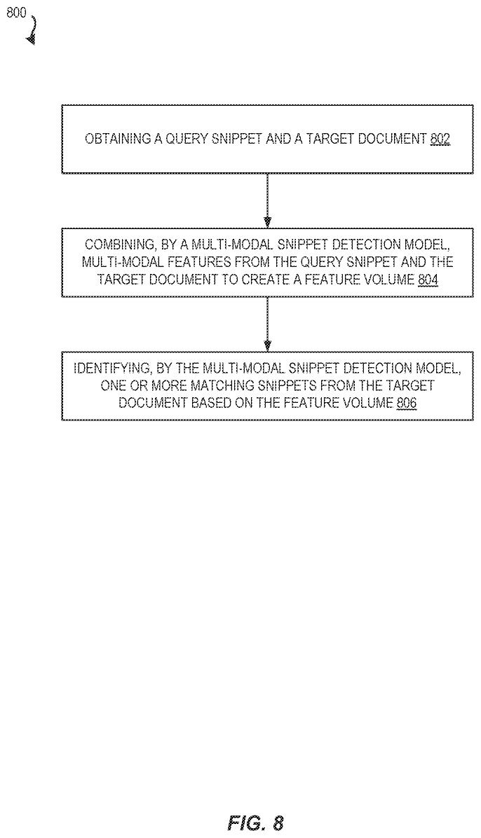

FIGS. 1-7, the corresponding text, and the examples, provide a number of different systems and devices that enables one-shot snippet search of target documents. In addition to the foregoing, embodiments can also be described in terms of flowcharts comprising acts and steps in a method for accomplishing a particular result. For example, FIG. 8 illustrates a flowchart of an exemplary method in accordance with one or more embodiments. The method described in relation to FIG. 8 may be performed with fewer or more steps/acts or the steps/acts may be performed in differing orders. Additionally, the steps/acts described herein may be repeated or performed in parallel with one another or in parallel with different instances of the same or similar steps/acts.

FIG. 8 illustrates a flowchart 800 of a series of acts in a method of one-shot document snippet search in accordance with one or more embodiments. In one or more embodiments, the method 800 is performed in a digital medium environment that includes the document search system 700. The method 800 is intended to be illustrative of one or more methods in accordance with the present disclosure and is not intended to limit potential embodiments. Alternative embodiments can include additional, fewer, or different steps than those articulated in FIG. 8.

As illustrated in FIG. 8, the method 800 includes an act 802 of obtaining a query snippet and a target document. As discussed, in some embodiments, a user may provide the query snippet and target document. For example, the user may upload or otherwise provide access to the target document and a document that includes the query snippet. In some embodiments, the user may select the query snippet from examples made available by the document search system.

In some embodiments, the method may further include extracting, by a plurality of encoders, the first multi-modal features from the query snippet and the second multi-modal features from the target document. As discussed, the document search system may include a feature extractor that includes multiple encoders, each corresponding to a different modality being encoded. In some embodiments, the plurality of encoders includes one or more of a text encoder, an image encoder, and a layout encoder.

As illustrated in FIG. 8, the method 800 includes an act 804 of combining, by a multi-modal snippet detection model, first multi-modal features from the query snippet and second multi-modal features from the target document to create a feature volume. As discussed, the multi-modal features may be combined using a co-attention module and a cross-attention module. This enables feature sets to be created by combining like features from the query snippet and the target document (e.g., co-attention) and feature sets to be created by combining unlike features from the query snippet and the target document (e.g., cross-attention).

For example, in some embodiments, combining the multi-modal features includes obtaining a first plurality of feature vectors from the first multi-modal features, wherein each feature vector from the first plurality of feature vectors is associated with a different feature type and obtaining a second plurality of feature vectors from the second multi-modal features, wherein the second plurality of feature vectors include feature vectors corresponding to the feature types of the first plurality of feature vectors. A co-attention module generates a plurality of co-attention feature sets by combining feature vectors of like feature types from the first plurality of feature vectors and the second plurality of feature vectors.

Additionally, in some embodiments, combining the multi-modal features includes obtaining the first plurality of feature vectors from the first multi-modal features and obtaining the second plurality of feature vectors from the second multi-modal features. A cross attention module generates a plurality of cross-attention feature sets by combining feature vectors of unlike feature types from the first plurality of feature vectors and the second plurality of feature vectors. A feature volume is then generated by combining the plurality of co-attention feature sets with the plurality of cross-attention feature sets. For example, the co-attention feature sets and the cross-attention feature sets may be concatenated.

As illustrated in FIG. 8, the method 800 includes an act 806 of identifying, by the multi-modal snippet detection model, one or more matching snippets from the target document based on the feature volume. In some embodiments, identifying, by the multi-modal snippet detection model, one or more matching snippets includes identifying hierarchical features from the feature volume. A region proposal network then determines one or more regions of the target document based on the hierarchical features. A region of interest network can then determine bounding data associated with the one or more regions of interest, the bounding data corresponding to the one or more matching snippets from the target document.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other non-transitory storage medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 9 illustrates, in block diagram form, an exemplary computing device 900 that may be configured to perform one or more of the processes described above. One will appreciate that one or more computing devices such as the computing device 900 may implement the document search system. As shown by FIG. 9, the computing device can comprise a processor 902, memory 904, one or more communication interfaces 906, a storage device 908, and one or more I/O devices/interfaces 910. In certain embodiments, the computing device 900 can include fewer or more components than those shown in FIG. 9. Components of computing device 900 shown in FIG. 9 will now be described in additional detail.

In particular embodiments, processor(s) 902 includes hardware for executing instructions, such as those making up a computer program. As an example, and not by way of limitation, to execute instructions, processor(s) 902 may retrieve (or fetch) the instructions from an internal register, an internal cache, memory 904, or a storage device 908 and decode and execute them. In various embodiments, the processor(s) 902 may include one or more central processing units (CPUs), graphics processing units (GPUs), field programmable gate arrays (FPGAs), systems on chip (SoC), or other processor(s) or combinations of processors.

The computing device 900 includes memory 904, which is coupled to the processor(s) 902. The memory 904 may be used for storing data, metadata, and programs for execution by the processor(s). The memory 904 may include one or more of volatile and non-volatile memories, such as Random Access Memory (“RAM”), Read Only Memory (“ROM”), a solid state disk (“SSD”), Flash, Phase Change Memory (“PCM”), or other types of data storage. The memory 904 may be internal or distributed memory.

The computing device 900 can further include one or more communication interfaces 906. A communication interface 906 can include hardware, software, or both. The communication interface 906 can provide one or more interfaces for communication (such as, for example, packet-based communication) between the computing device and one or more other computing devices 900 or one or more networks. As an example and not by way of limitation, communication interface 906 may include a network interface controller (NIC) or network adapter for communicating with an Ethernet or other wire-based network or a wireless NIC (WNIC) or wireless adapter for communicating with a wireless network, such as a WI-FI. The computing device 900 can further include a bus 912. The bus 912 can comprise hardware, software, or both that couples components of computing device 900 to each other.

The computing device 900 includes a storage device 908 includes storage for storing data or instructions. As an example, and not by way of limitation, storage device 908 can comprise a non-transitory storage medium described above. The storage device 908 may include a hard disk drive (HDD), flash memory, a Universal Serial Bus (USB) drive or a combination these or other storage devices. The computing device 900 also includes one or more input or output (“I/O”) devices/interfaces 910, which are provided to allow a user to provide input to (such as user strokes), receive output from, and otherwise transfer data to and from the computing device 900. These I/O devices/interfaces 910 may include a mouse, keypad or a keyboard, a touch screen, camera, optical scanner, network interface, modem, other known I/O devices or a combination of such I/O devices/interfaces 910. The touch screen may be activated with a stylus or a finger.

The I/O devices/interfaces 910 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O devices/interfaces 910 is configured to provide graphical data to a display for presentation to a user. The graphical data may be representative of one or more graphical user interfaces and/or any other graphical content as may serve a particular implementation.

In the foregoing specification, embodiments have been described with reference to specific exemplary embodiments thereof. Various embodiments are described with reference to details discussed herein, and the accompanying drawings illustrate the various embodiments. The description above and drawings are illustrative of one or more embodiments and are not to be construed as limiting. Numerous specific details are described to provide a thorough understanding of various embodiments.

Embodiments may include other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

In the various embodiments described above, unless specifically noted otherwise, disjunctive language such as the phrase “at least one of A, B, or C,” is intended to be understood to mean either A, B, or C, or any combination thereof (e.g., A, B, and/or C). As such, disjunctive language is not intended to, nor should it be understood to, imply that a given embodiment requires at least one of A, at least one of B, or at least one of C to each be present.

We claim:

1. A method comprising:
obtaining a query snippet and a target document;
combining, by a multi-modal snippet detection model, first multi-modal features from the query snippet and second multi-modal features from the target document to create a feature volume; and
identifying, by the multi-modal snippet detection model, one or more matching snippets from the target document that match the query snippet based on the feature volume.

2. The method of claim 1, further comprising:
extracting, by a plurality of encoders, the first multi-modal features from the query snippet and the second multi-modal features from the target document.

3. The method of claim 2, wherein the plurality of encoders includes one or more of a text encoder, an image encoder, and a layout encoder.

4. The method of claim 1, wherein combining, by a multi-modal snippet detection model, first multi-modal features from the query snippet and second multi-modal features from the target document to create a feature volume further comprises:
obtaining a first plurality of feature vectors from the first multi-modal features, wherein each feature vector from the first plurality of feature vectors is associated with a different feature type;
obtaining a second plurality of feature vectors from the second multi-modal features, wherein the second plurality of feature vectors include feature vectors corresponding to the feature types of the first plurality of feature vectors; and
generating, by a co-attention module, a plurality of co-attention feature sets by combining feature vectors of like feature types from the first plurality of feature vectors and the second plurality of feature vectors.

5. The method of claim 4, further comprising:
obtaining the first plurality of feature vectors from the first multi-modal features;
obtaining the second plurality of feature vectors from the second multi-modal features; and
generating, by a cross-attention module, a plurality of cross-attention feature sets by combining feature vectors of unlike feature types from the first plurality of feature vectors and the second plurality of feature vectors.

6. The method of claim 5, further comprising:
generating the feature volume by combining the plurality of co-attention feature sets with the plurality of cross-attention feature sets.

7. The method of claim 1, wherein identifying, by the multi-modal snippet detection model, one or more matching snippets from the target document based on the feature volume further comprises:
identifying hierarchical features from the feature volume;
determining, by a region proposal network; one or more regions of the target document based on the hierarchical features; and
determining, by a region of interest network, bounding data associated with the one or more regions of interest, the bounding data corresponding to the one or more matching snippets from the target document.

8. A non-transitory computer-readable medium storing executable instructions, which when executed by a processing device, cause the processing device to perform operations comprising:
obtaining a query snippet and a target document;
combining, by a multi-modal snippet detection model, first multi-modal features from the query snippet and second multi-modal features from the target document to create a feature volume; and
identifying, by the multi-modal snippet detection model, one or more matching snippets from the target document that match the query snippet based on the feature volume.

9. The non-transitory computer-readable medium of claim 8, wherein the operations further comprise:
extracting, by a plurality of encoders, the first multi-modal features from the query snippet and the second multi-modal features from the target document.

10. The non-transitory computer-readable medium of claim 9, wherein the plurality of encoders includes one or more of a text encoder, an image encoder, and a layout encoder.

11. The non-transitory computer-readable medium of claim 8, wherein the operation of combining, by a multi-modal snippet detection model, first multi-modal features from the query snippet and second multi-modal features from the target document to create a feature volume further comprises:
obtaining a first plurality of feature vectors from the first multi-modal features, wherein each feature vector from the first plurality of feature vectors is associated with a different feature type;
obtaining a second plurality of feature vectors from the second multi-modal features, wherein the second plurality of feature vectors include feature vectors corresponding to the feature types of the first plurality of feature vectors; and
generating, by a co-attention module, a plurality of co-attention feature sets by combining feature vectors of like feature types from the first plurality of feature vectors and the second plurality of feature vectors.

12. The non-transitory computer-readable medium of claim 11, wherein the operations further comprise:
obtaining the first plurality of feature vectors from the first multi-modal features;
obtaining the second plurality of feature vectors from the second multi-modal features; and
generating, by a cross-attention module, a plurality of cross-attention feature sets by combining feature vectors of unlike feature types from the first plurality of feature vectors and the second plurality of feature vectors.

13. The non-transitory computer-readable medium of claim 12, wherein the operations further comprise:
generating the feature volume by combining the plurality of co-attention feature sets with the plurality of cross-attention feature sets.

14. The non-transitory computer-readable medium of claim 8, wherein the operation of identifying, by the multi-modal snippet detection model, one or more matching snippets from the target document based on the feature volume further comprises:
identifying hierarchical features from the feature volume;
determining, by a region proposal network; one or more regions of the target document based on the hierarchical features; and
determining, by a region of interest network, bounding data associated with the one or more regions of interest, the bounding data corresponding to the one or more matching snippets from the target document.

15. A system comprising:
a memory component; and
a processing device coupled to the memory component, the processing device to perform operations comprising:
generating, by a plurality of encoders, first multi-modal features for a query snippet and second multi-modal features for a target document;
generating, by a multi-modal snippet detection model, a feature volume based on first multi-modal features from the query snippet and second multi-modal features from the target document; and
predicting, by the multi-modal snippet detection model, one or more bounding boxes corresponding to matching snippets from the target document that match the query snippet based on the feature volume.

16. The system of claim 15, wherein the plurality of encoders includes a text encoder, an image encoder, and a layout encoder.

17. The system of claim 15, wherein the operation of generating, by a multi-modal snippet detection model, a feature volume based on first multi-modal features from the query snippet and second multi-modal features from the target document further comprises:
obtaining a first plurality of feature vectors from the first multi-modal features, wherein each feature vector from the first plurality of feature vectors is associated with a different feature type;
obtaining a second plurality of feature vectors from the second multi-modal features, wherein the second plurality of feature vectors include feature vectors corresponding to the feature types of the first plurality of feature vectors; and
generating, by a co-attention module, a plurality of co-attention feature sets by combining feature vectors of like feature types from the first plurality of feature vectors and the second plurality of feature vectors.

18. The system of claim 17, wherein the operations further comprise:
obtaining the first plurality of feature vectors from the first multi-modal features;
obtaining the second plurality of feature vectors from the second multi-modal features; and
generating, by a cross-attention module, a plurality of cross-attention feature sets by combining feature vectors of unlike feature types from the first plurality of feature vectors and the second plurality of feature vectors.

19. The system of claim 18, wherein the operations further comprise:
generating the feature volume by combining the plurality of co-attention feature sets with the plurality of cross-attention feature sets.

20. The system of claim 15, wherein the operation of predicting, by the multi-modal snippet detection model, one or more bounding boxes corresponding to matching snippets from the target document based on the feature volume further comprises:
identifying hierarchical features from the feature volume;
determining, by a region proposal network; one or more regions of the target document based on the hierarchical features; and
determining, by a region of interest network, the one or more bounding boxes based on the one or more regions of interest.
